(19) United States
(12) Patent Application Publication
(10) Pub. No.: US 2011/0100944 A1
(43) Pub. Date: May 5, 2011

(54) PERISTALTIC TEAT

(75) Inventors: Johannes Tseard Van Der Kooi, Drachten (NL); Fokke Roelof Voorhorst, Drachten (NL)

(73) Assignee: KONINKLIJKE PHILIPS ELECTRONICS N.V., EINDHOVEN (NL)

(21) Appl. No.: 13/000,738

(22) PCT Filed: Jul. 2, 2009
(86) PCT No.: PCT/IB09/52885

§ 371 Date: Dec. 22, 2010

(30) Foreign Application Priority Data
Jul. 7, 2008 (EP) 08159792.4

(51) Int. Cl. A61J 11/00

(52) U.S. Cl. 215/11.1

(57) ABSTRACT

The peristaltic teat is a cleanable teat which rewards the baby for making the same natural peristaltic tongue movement it makes at the mother's breast. The reward is that the baby gets (more) milk when making the correct movement. The consequence is that the baby will use the same drinking mechanism as at the breast. Hence bottle feeding will become closer to breast feeding which makes the combination of bottle feeding and breast feeding easier.

### FIELD OF THE INVENTION

The present invention relates to a teat for a baby feeding bottle, and more particularly to a teat that is configured to encourage a baby to use a natural breast-feeding action.

### BACKGROUND OF THE INVENTION

Many different designs of teats for baby feeding bottles are known. However, a disadvantage of known teats is that their configuration requires the baby to use a different drinking technique than that required when feeding from the mother's breast, since known teats do not provide milk flow in the same way as a mother's breast does. More specifically, when a baby feeds from its mother's breast, the baby applies the following actions:

1. Sucking—to form a teat from the nipple, areola and underlying breast tissue. The negative pressure rewards the baby with a little milk.

2. Peristaltic movement—the baby performs a peristaltic stripping movement with its tongue along the teat towards its mouth. The major part of the milk flow is caused by this movement.

The combination of the above two actions stimulates the hormone production of the mother needed for the ‘let down reflex’ which causes the milk glands in the breast to release milk into the milk ducts. In this way, the initial sucking causes the let down reflex and thus doesn't immediately provide the baby with milk. Only after 4 or 5 feeding movements does the baby receive milk.

FIG. 1 illustrates the natural peristaltic breast feeding action: in diagram ‘a’, a teat is formed between the baby's tongue and palate. At the base of the teat, a seal is formed by the lips and tongue. In diagram ‘b’, the lower jaw is raised, compressing the teat against the baby's upper jaw and trapping a pool of milk inside the nipple. In diagram ‘c’, a compression wave moves along the teat in a posterior direction, while the posterior part of the tongue forms a groove, channeling the milk into the back of the mouth. In diagram ‘d’, the compression wave squeezes milk from the nipple. In diagram ‘e’, as the tongue pushes against the palate and milk is collected, the baby usually swallows. In diagram ‘f’, depression of the back of the tongue draws the nipple once again inside the mouth, while the jaw lowers allowing milk to flow from the breast into the nipple. The cycle then repeats from diagram ‘a’ again.

When a baby is fed from a bottle having an artificial teat, due to the construction of known bottle feeding teats, the feeding action that the baby is required to use is different to that which the baby must use when feeding from its mother's breast and the baby is only rewarded with milk for applying a negative pressure to the artificial teat (i.e. sucking), but not for using the natural peristaltic tongue action described above. This can lead to a condition in the baby known as ‘nipple confusion’, whereby the baby is unable to determine a correct feeding action to use when being fed from a bottle and from its mother's breast, and the baby unlearns the peristaltic feeding action and hence its natural breast-feeding skills. Accordingly, feeding problems occur interchanging between breast-feeding and bottle feeding.

Known teats for bottle feeding are disclosed in EPO496892, U.S. Pat. No. 4,993,568 and US 2004/0245203. However, these teats are configured to encourage a baby to adopt a chewing action to obtain milk from the bottle, and therefore do not encourage a baby to adopt the same peristaltic feeding action as used when feeding at the mother's breast. Furthermore, the construction of each teat is such that a baby would still be able to obtain a sufficient flow of milk from the teat simply by using sucking action alone.

US 2003/0089676, JP2001009008 and WO 2007/137440 all disclose teats on which a peristaltic feeding action can be performed by the baby in order to obtain milk from the feeding bottle. The teat disclosed in US2003/0089676 merely facilitates this action by attempting to recreate a similar elasticity to a natural mother's teat, and JP2001009008 merely facilitates this action by providing a teat which is able to elongate. WO 2007/137440 discusses a peristaltic action, however such an action is used to impart a vacuum, which can be obtained simply by using sucking action alone. Therefore, none of the teats encourages the baby to use the correct peristaltic feeding action by rewarding the baby for doing so and delivering less milk if such an action is not used. Each teat design merely facilitates use of a peristaltic feeding action.

Known teats are also disclosed in US2004/0124168 and U.S. Pat. No. 6,818,162. Both of these documents disclose teats for baby feeding bottles which comprise one or more small tubes formed within a solid teat. The solid construction of these teats makes closure of the tubes difficult to achieve a peristaltic feeding action, and also the small tubes means that the teat is difficult to clean.

### SUMMARY OF THE INVENTION

It is an object of the present invention to provide a teat for a baby feeding bottle which substantially alleviates or overcomes the problems mentioned above.

Accordingly, the present invention provides a teat for use with a feeding bottle having a mouthpiece on which a baby sucks during feeding extending from the main body with one or more apertures therein for the flow of milk out of the teat, a main body from which the mouthpiece extends, and an inner core disposed within the mouthpiece to define a fluid duct between the mouthpiece and the inner core, the mouthpiece and the inner core being configured such that during feeding, the mouthpiece and/or the inner core deform so as to make a peristaltic action possible which causes milk to flow along said duct and through said aperture.

In a preferred embodiment, the inner core within the mouthpiece defines a plurality of separate ducts for the flow of milk along the ducts and out through the one or more apertures.

Preferably, the teat includes a main body from which the mouthpiece extends, and the inner core extends from the mouthpiece into the main body.

Preferably, the teat comprises at least one valve means within the mouthpiece which divides the or each duct into discrete sections and which is operable to allow milk to flow in one direction out of the teat but closes to resist the flow of milk in the opposite direction.

Preferably, the valve means comprises at least one flexible flange extending between the mouthpiece and the inner core which divides the or each duct into discrete sections and which is moveable to allow milk to flow in one direction out of the teat but closes to resist the flow of milk in the opposite direction.

The teat preferably comprises a plurality of flexible flanges.

The or each flange is preferably secured to the mouthpiece is biased against the inner core, and the or each flange is preferably formed integrally with the mouthpiece.

Alternatively, the or each flange may be secured to the inner core and is biased against the mouthpiece, and the or each flange may be formed integrally with the inner core.

In a preferred embodiment, the inner core includes an absorbent outer surface, and the absorbent outer surface of the inner core may be made from foam.

The inner core may comprise a sealed flexible tube filled with incompressible material, and the incompressible material is preferably a fluid. The incompressible material may be silicone gel, and the tube may be made from a stretchable material.

The tube has may have a corrugated surface with the corrugations extending in a longitudinal direction of the mouthpiece.

In another preferred embodiment, the mouthpiece includes elongate channels along its length which comprise said duct(s) and the inner core is flexible and includes longitudinal ribs extending into said channels, such that compression of the inner core causes the longitudinal ribs to extend further into the channels to close the channels and thereby close the duct(s).

In another preferred embodiment, the inner core comprises an elongate recess along its length to define the or each duct between the mouthpiece and the inner core within the recess.

Preferably, the inner core is removable from the mouthpiece. Conveniently, the teat can be inverted to aid cleaning of the teat and/or to facilitate removal of the inner core.

In a preferred embodiment, the inner core is more rigid than the mouthpiece.

Preferably, a perimeter surface of the inner core lies against the mouthpiece and a face is formed in the inner core, spaced from the mouthpiece, the duct being defined between said face and the mouthpiece.

Advantageously, the inner core is integrally formed with the mouthpiece.

In one embodiment, an end of the inner core, distal to the main body, is integrally formed with the mouthpiece.

Conveniently, a support frame extends from the inner core through the main body and which, during use, locates against the main body and/or a bottle to support the inner core.

The inner core may include a hollow bore extending longitudinally there through for the additional flow of milk.

The present invention also provides a baby feeding bottle including a teat as described above. Conveniently, the baby feeding bottle includes a pressure release valve to equalize negative pressure within the bottle during feeding.

### BRIEF DESCRIPTION OF THE DRAWINGS

Preferred embodiments of the present invention will now be described, by way of example only, with reference to FIGS. 2-8D of the accompanying drawings, in which:

FIG. 1 illustrates a peristaltic feeding action of a baby;

FIG. 2 shows a cross-sectional perspective view of a teat according to the present invention;

FIG. 3 shows a schematic cross-sectional view along the line X-X of the mouthpiece portion of the teat of FIG. 2;

FIG. 4 shows an equivalent schematic cross-sectional view to that of FIG. 3 but of a mouthpiece portion of a second embodiment of the present invention;

FIG. 5A shows an equivalent schematic cross-sectional view to that of FIG. 3 but of a mouthpiece portion of a third embodiment of the present invention;

FIGS. 5B and 5C show schematic transverse cross-sectional views along the lines Z-Z and Y-Y of FIG. 5A respectively;

FIG. 6A shows an equivalent schematic cross-sectional view to that of FIG. 3 but of a mouthpiece portion of a fourth embodiment of the present invention;

FIGS. 6B and 6C show schematic transverse cross-sectional views along the lines B-B and A-A of FIG. 6A respectively

FIG. 7 shows an equivalent schematic cross-sectional view to that of FIG. 3 but of a mouthpiece portion of a fifth embodiment of the present invention;

FIG. 8A shows a perspective view of a mouthpiece portion of a sixth embodiment of the present invention;

FIG. 8B shows a schematic longitudinal cross-sectional view along the line C-C of the mouthpiece portion of the teat of FIG. 8A;

FIGS. 8C and 8D show schematic transverse cross-sectional views along the lines D-D and E-E respectively in FIG. 8B.

FIG. 9A shows a schematic cross-sectional view of a teat of a seventh embodiment of the present invention;

FIG. 9B shows a schematic transverse cross-sectional view along the lines F-F of FIG. 9A;

FIG. 10A shows a schematic cross-sectional view of a teat of an eighth embodiment of the present invention;

FIG. 10B shows a schematic transverse cross-sectional view along the lines G-G of FIG. 10A;

FIG. 10C shows a schematic cross-sectional view of the teat shown in FIG. 10A with an inner core drawn from a hollow outer membrane to facilitate cleaning of the teat; and

FIG. 10D shows a schematic transverse cross-sectional view along the lines H-H of FIG. 10C.

FIG. 11A shows a schematic cross-sectional view of a teat of a ninth embodiment of the present invention;

FIG. 11B shows a schematic transverse cross-sectional view along the lines J-J of FIG. 11A;

FIG. 11C shows an exploded schematic cross-sectional view of the teat shown in FIG. 11A;

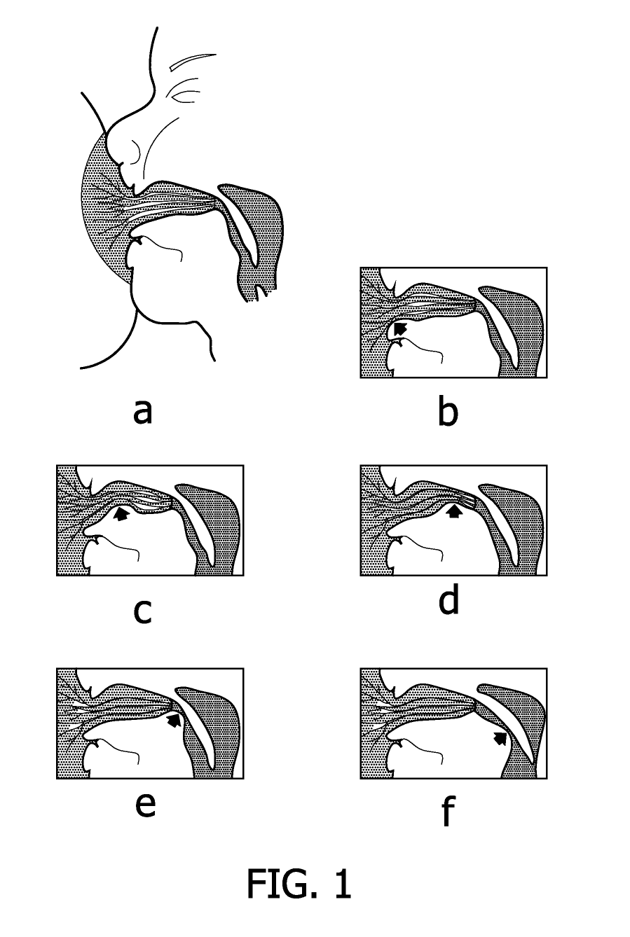

### DETAILED DESCRIPTION OF THE EMBODIMENTS

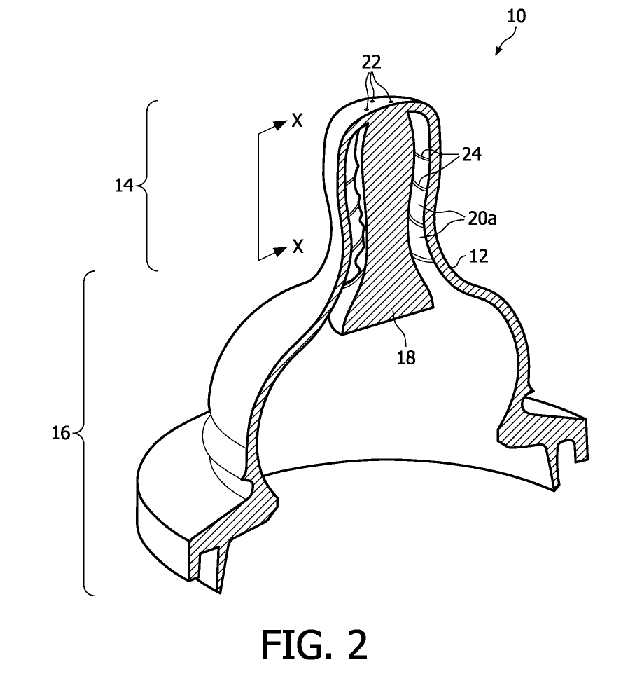

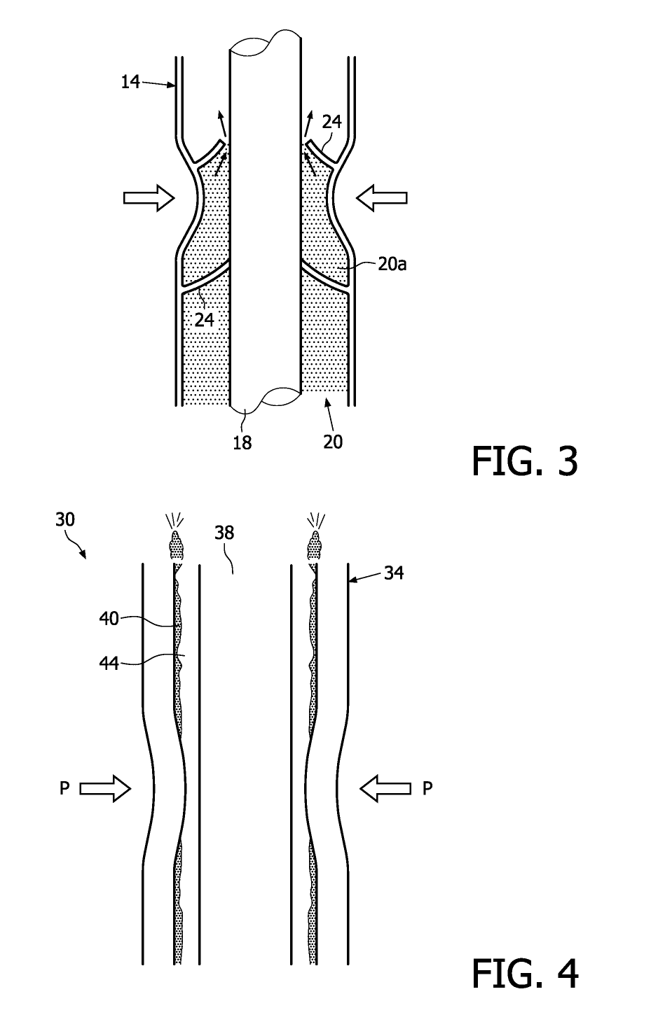

Referring now to FIGS. 2 and 3, a teat 10 of a first embodiment of the present invention is shown comprising a hollow outer membrane 12 having a mouthpiece portion 14 and a main body portion 16. An inner core 18 comprising a substantially cylindrical plug, is disposed within the mouthpiece 14 and extends slightly into the main body 16. A duct 20 is thereby defined between the membrane 12 and the inner core 18 for the flow of milk, in use, from a feeding bottle (not shown) to which the teat 10 is to be attached, through the duct 20, and into a baby's mouth through a plurality of apertures 22 formed in a distal end of the mouthpiece 14 remote from the main body 16. The inner surface of the mouthpiece 14 is provided with a plurality of flanges 24 extending inwardly and around its circumference. The flanges 24 are curved towards the distal end of the mouthpiece 14 and bias against the inner core 18 such that the inner perimeter of each flange is in contact with and seals against the outer surface of the inner core 18. This configuration is such that the duct 20 is divided into a plurality of ring-shaped chambers 20a and the flanges 24 act as one-way valves by permitting the flow of milk in a first direction from a feeding bottle towards the apertures 22 in the distal end of the mouthpiece 14, but sealing against the inner core 18 to prevent the flow of milk in the opposite direction.

Operation of the first embodiment of the present invention will now be described. In use, the teat 10 is attached to a feeding bottle in a known manner. The baby sucks on the mouthpiece 14 which is sufficient to cause a small flow of milk from the bottle into the duct 20. The resilience of the flanges 24 is such that the sucking action of the baby and the resulting pressure difference between the baby's mouth and the inside of the bottle can cause a small amount of milk to flow along the duct 20 by deflecting the flanges 24 a small amount away from the inner core 18. However, in order to obtain a full flow of milk from the bottle out of the teat 10, a baby must use a peristaltic feeding action by which a wave of compression is exerted by the baby's tongue on the mouthpiece 14 as described above, in the direction of the distal end of the mouthpiece 14. As each of the ring-shaped chambers 20a is compressed by the baby's tongue, the pressure in the chamber 20a increases and so the milk is forced into the adjacent chamber 20a in the direction of the distal end of the mouthpiece 14. Due to the flanges 24 acting as one-way valves, the milk cannot flow into the adjacent chamber 20a in the opposite direction to the distal end of the mouthpiece 14. After the milk has been forced into the adjacent ring-shaped chamber 20a, the peristaltic action of the baby's tongue then compresses said adjacent chamber 20a and forces the milk further through the duct 20 into the next chamber 20a and this action is repeated until the milk is at the distal end of the mouthpiece, where after it is expelled into the baby's mouth out of the apertures 22. The baby then commences the peristaltic feeding action at the main body 16 end of the mouthpiece 14 again and the process is repeated to achieve continuous feeding.

It will be appreciated that the teat 10 of the first embodiment of the invention is configured so that the above-described peristaltic feeding action provides the baby with the most amount of milk, compared to if the baby was to use a sucking or a chewing action. Accordingly, the baby is rewarded for using the same feeding action as with natural breast feeding, and so the problem of nipple confusion in switching between bottle feeding and breast feeding is prevented since the baby learns to use the same feeding action for both feeding methods. It should be noted that the stiffness of the flanges 24 can be chosen and manufactured to reward the sucking and peristaltic feeding action in any proportion.

In order to facilitate cleaning of the above embodiment of the invention, the inner core 18 is removable from the mouthpiece 14 and membrane 12. This is achievable by inverting the membrane (i.e. turning it inside out) and then the membrane 12 can be cleaned separately from the inner core 18. However, in alternative embodiments of the present invention, the inner core 18 may not be removable from the mouthpiece 14, yet the one-piece teat may still be capable of being inverted in order to facilitate cleaning with the inner core 18 remaining attached to the mouthpiece 14. In both cases, the inner core 18 can aid the inverting of the teat.

Un-illustrated variations in the above-described first embodiment are intended to fall within the scope of the claims hereafter, for example, the flanges 24 may be formed on the inner core 18 rather than on the inner surface of the mouthpiece 14 of the membrane 12. Also, the sucking action of the child may also be rewarded by provided a continuous duct which extends through the length of the inner core 18.

Manufacture of the membrane 12 can be achieved by moulding it inside out, which is a known teat manufacturing technique.

It will be appreciated that a peristaltic feeding action essentially comprises closing a duct/channel in which fluid is contained, and moving the closed position in the direction of the exit apertures to expel the fluid therefrom. In the above-described embodiment, the peristaltic feeding action of the baby is encouraged and rewarded by the milk duct 20 formed in the mouthpiece 14 being divided into a plurality of discrete chambers 20a and the peristaltic action, combined with the one-way valve action of the flanges 24, resulting in the milk being progressively fed from one chamber 20a of the duct 20 to the next until it is expelled from the mouthpiece through the apertures 22. However, alternative configurations of mouthpieces are intended to fall within the scope of the claims and the present invention which do not include such discrete chambers/valves, whereby milk is discharged from a bottle out of the mouthpiece using a continuous peristaltic action which closes a duct formed between the mouthpiece and inner core, and the point of closure of the duct moves along the mouthpiece towards the distal end thereof thereby forcing the milk out of the apertures in the distal end of the mouthpiece into the baby's mouth. A second embodiment of a teat 30 of the present invention which operates according to this latter principle will now be described with reference to FIG. 4. The overall construction of the teat 30 is largely the same as that of the teat 10 first embodiment described above, and only the specific construction of the mouthpiece portion 34 differs, as described below. Accordingly, FIG. 4 only shows a schematic cross-section of the mouthpiece 34 of the teat 30 of the second embodiment. The teat 30 includes an inner core 38 disposed within the mouthpiece 34 such that a duct 40 for the flow of milk is defined there between. A plurality of apertures (not shown) are formed in the distal end of the mouthpiece 34 as described above with reference to the first embodiment of the invention. However, the inner core 38 includes an absorbent foam outer surface 44.

Operation of the second embodiment of the present invention will now be described. In use, the teat 30 is attached to a feeding bottle in a known manner. The baby sucks on the mouthpiece 34 which is sufficient to cause a small flow of milk from the bottle into the duct 40, some of which is absorbed by the foam surface 44. The density of the foam surface 44 and the size of the duct 40 is such that the sucking action of the baby and the resulting pressure difference between the baby's mouth and the inside of the bottle can cause only a small amount of milk to flow along the duct 40. However, in order to obtain a full flow of milk from the bottle out of the teat 30, a baby must use a peristaltic feeding action as described above. At the point of compression of the mouthpiece 34, shown by arrows P in FIG. 4, the inner surface of the mouthpiece 34 compresses the foam surface 44, expelling the milk therefrom and closing the duct 40. As the baby exerts a peristaltic feeding action on the mouthpiece 34, the compression point P where the duct 40 is closed moves along the mouthpiece 34, thereby pushing ahead of it the milk in the duct 40 and absorbed in the foam outer surface 44, until the compression point P reaches the distal end of the mouthpiece 34 and the milk is expelled out of the apertures 42 into the baby's mouth. The reduction in pressure caused in the bottle by this action draws more milk into the duct 40 behind the compression point P. After the milk is expelled from the mouthpiece 34, the baby then repeats the feeding action starting with a compression point P at the main body end of the mouthpiece 34 and draws the milk along the duct 40 and out of the mouthpiece 34 as described above.

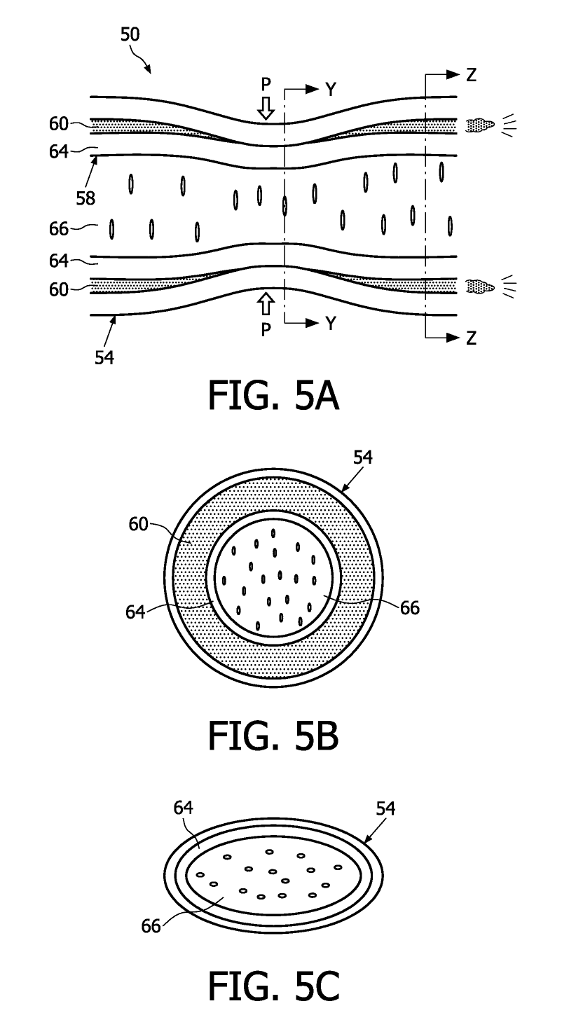

A third embodiment of a teat 50 of the present invention will now be described with reference to FIGS. 5A-5C. As with FIG. 4, the overall construction of the teat 50 is largely the same as that of the teat 10 of the first embodiment described above, and only the specific construction of a mouthpiece portion 54 differs, as described below. Accordingly, FIGS. 5A-5C only show a schematic cross-section of the mouthpiece 54 of the teat 50 of the third embodiment. FIG. 5A shows a longitudinal cross-section along the length of the mouthpiece, and FIGS. 5B and 5C show transverse cross-sectional views along the lines Z-Z and Y-Y respectively of the mouthpiece 54 in un-deformed and deformed states, as described below. The teat 50 includes an inner core 58 disposed within the mouthpiece 54 such that a duct 60 for the flow of milk is defined there between. A plurality of apertures (not shown) are formed in the distal end of the mouthpiece 54 as described above with reference to the first embodiment of the invention. The inner core 58 comprises a sealed flexible and stretchable tube 64 filled with a non-compressible but deformable material 66, for example, but not limited to, silicone gel. As can be seen from FIG. 5B, when the mouthpiece 54 is not compressed, the duct 60 is open. However, when the mouthpiece 54 is compressed, as shown by arrows P in FIG. 5A and in FIG. 5C, the inner core 58 is deformed. However, since the material 66 filling the tube 64 is incompressible, the inner core 58 deforms within the mouthpiece 54 and the incompressible material 66 exerts an internal pressure on the stretchable tube 64, causing it to expand and thereby fill the inside of the mouthpiece 54, closing the duct 60.

Operation of the third embodiment of the present invention will now be described. In use, the teat 50 is attached to a feeding bottle in a known manner. The baby sucks on the mouthpiece 54, which is sufficient to cause a small flow of milk from the bottle into the duct 60. The size of the mouthpiece 54, the inner core 58 and the resulting duct 60 is such that the sucking action of the baby and the resulting pressure difference between the baby's mouth and the inside of the bottle can cause only a small amount of milk to flow along the duct 60. However, in order to obtain a full flow of milk from the bottle out of the teat 50, a baby must use a peristaltic feeding action as described above. At the point of compression of the mouthpiece 54, shown by arrows P in FIG. 5A, the inner surface of the mouthpiece 54 contacts the inner core 58 and causes the inner core 58 to deform and close the duct 60, as described above. As the baby exerts a peristaltic feeding action on the mouthpiece 54, the compression point P where the duct 60 is closed moves along the mouthpiece 54, thereby pushing ahead of it the milk in the duct 60 until the compression point P reaches the distal end of the mouthpiece 54 and the milk is expelled out of the apertures into the baby's mouth. The reduction in pressure caused in the bottle by this action draws more milk into the duct 60 behind the compression point P. After the milk is expelled from the mouthpiece 54, the baby then repeats the feeding action starting with a compression point P at the main body end of the mouthpiece 54 and draws the milk along the duct 60 and out of the mouthpiece 54 as described above.

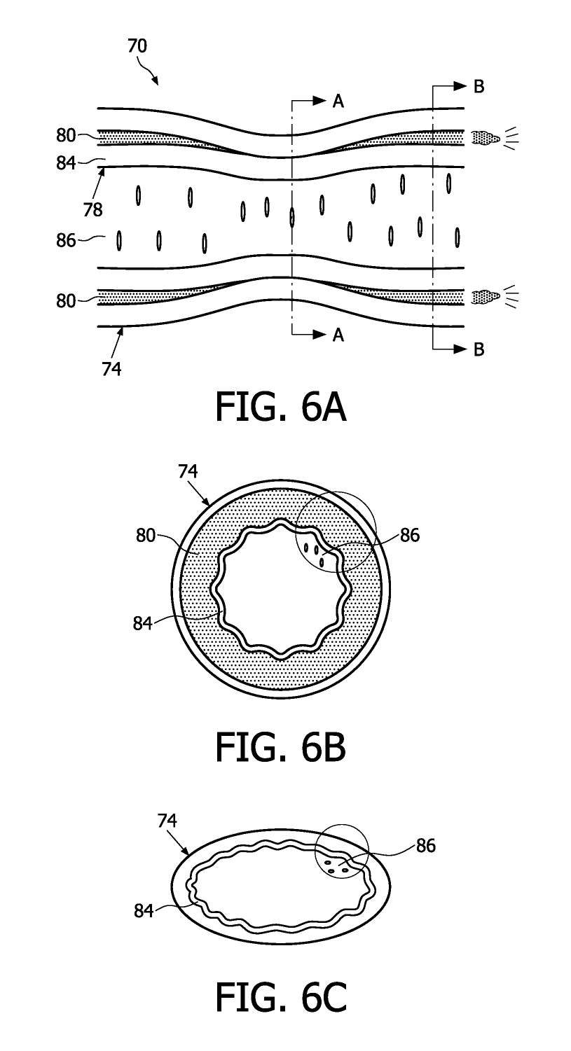

A teat 70 of a fourth embodiment of the present invention will now be described with reference to FIGS. 6A-6C. The fourth embodiment is similar to the third embodiment, and comprises teat 70 having a mouthpiece 74 with an inner core 78 disposed within the mouthpiece 74 such that a duct 80 for the flow of milk is defined there between. A plurality of apertures (not shown) are formed in the distal end of the mouthpiece 74 as described above with reference to the first embodiment of the invention. The inner core 78 comprises a sealed flexible tube 84 filled with a non-compressible but deformable material 86, for example, but not limited to, silicone gel. However, unlike the third embodiment, the tube 84 is formed in a corrugated or ribbed pattern. Therefore, the tube 84 does not need to be made from a stretchable material because when the mouthpiece 74, and thereby the inner core 78, is compressed, the incompressible material 86 exerts an internal pressure on the tube 84, causing the corrugations in the tube 84 to flatten out and so the tube 84 expands within the mouthpiece 74 and closes the duct 80. Aside from the above-mentioned difference, the fourth embodiment of the invention is identical to that of the third embodiment, and so operation thereof is as described above with reference to the third embodiment, and so will not be repeated here.

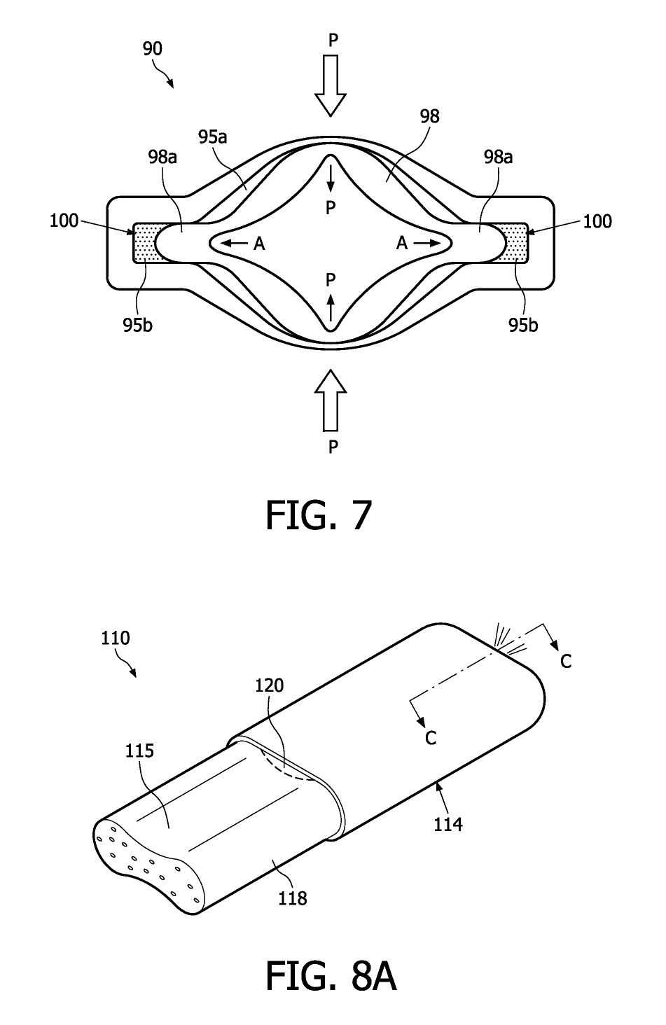

A fifth embodiment of a teat 90 of the present invention will now be described with reference to FIG. 7. The overall construction of the teat 90 is largely the same as that of the teat 10 of the first embodiment described above, and only the specific construction of a mouthpiece portion 94 differs, as described below. Accordingly, FIG. 7 only shows a schematic cross-section of the mouthpiece 94 of the teat 90 of the fifth embodiment. The teat 90 comprises a mouthpiece 94 which has a main central cavity 95a with two elongate channels 95b extending from each side of the main central cavity 95a and extending longitudinally along the length of the mouthpiece 94. The teat 90 includes a flexible inner core 98 disposed within the central cavity 95a. The inner core includes side ribs 98a which extend into the elongate channels 95b such that ducts 100 for the flow of milk are defined there between. A plurality of apertures (not shown) are formed in the distal end of the mouthpiece 94 as described above with reference to the first embodiment of the invention. As can be seen from FIG. 7, when the mouthpiece 94 is not compressed, the ducts 100 are open. However, when the mouthpiece 94 is compressed, as shown by arrows P, the inner core 98 is deformed and due to the shape of the inner core 98, the side ribs 98a are pushed in the direction of arrows A further into the elongate channels 95b, thereby closing the ducts 100.

Operation of the fifth embodiment of the present invention will now be described. In use, the teat 90 is attached to a feeding bottle in a known manner. The baby sucks on the mouthpiece 94, which is sufficient to cause a small flow of milk from the bottle into the ducts 100. The size of the inner core 98, elongate channels 95b and side ribs 98a, and the resulting ducts 100 are such that the sucking action of the baby and the resulting pressure difference between the baby's mouth and the inside of the bottle can cause only a small amount of milk to flow along the ducts 100. However, in order to obtain a full flow of milk from the bottle out of the teat 90, a baby must use a peristaltic feeding action as described above. At the point of compression of the mouthpiece 94, shown by arrows P in FIG. 7, the inner surface of the mouthpiece 94 contacts the inner core 98 and causes the inner core 98 to deform and close the ducts 100, as described above. As the baby exerts a peristaltic feeding action on the mouthpiece 94, the compression point P where the ducts 100 are closed moves along the mouthpiece 94, thereby pushing ahead of it the milk in the ducts 100 until the compression point P reaches the distal end of the mouthpiece 94 and the milk is expelled out of the apertures into the baby's mouth. The reduction in pressure caused in the bottle by this action draws more milk into the ducts 100 behind the compression point P. After the milk is expelled from the mouthpiece 94, the baby then repeats the feeding action starting with a compression point P at the main body end of the mouthpiece 94 and draws the milk along the ducts 100 and out of the mouthpiece 94 as described above.

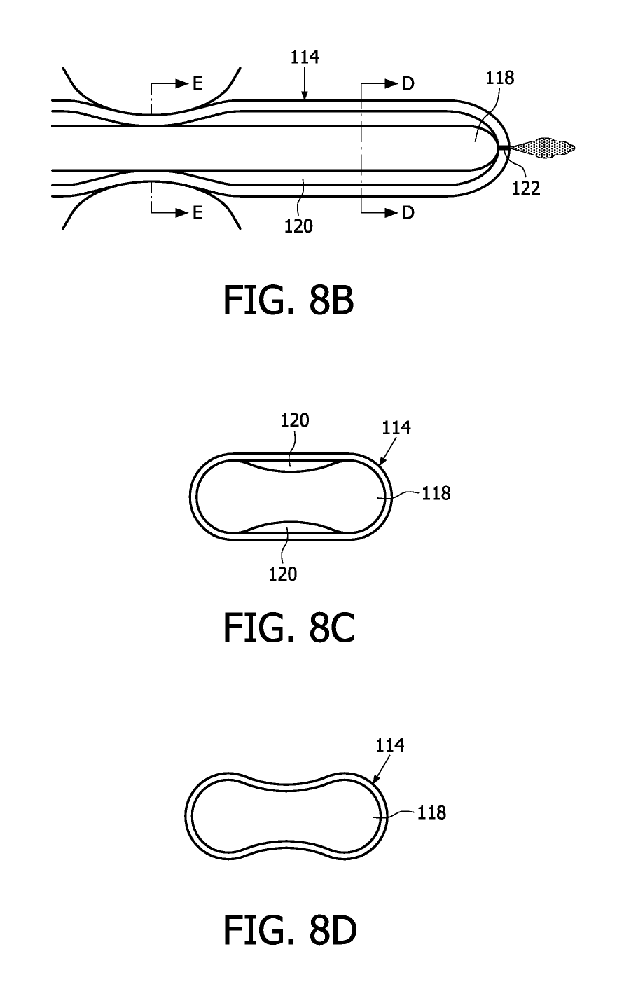

A sixth embodiment of a teat 110 of the present invention will now be described with reference to FIGS. 8A-8D. The overall construction of the teat 110 is largely the same as that of the teat 10 of the first embodiment described above, and only the specific construction of a mouthpiece portion 114 differs, as described below. Accordingly, FIGS. 8A-8D only show schematic views of the mouthpiece 114 of the teat 110 of the sixth embodiment. The teat 110 comprises a mouthpiece 114 and an inner core 118 disposed within the mouthpiece 114. The inner core 118 is shaped as a flattened circle in cross-section, as can be seen from FIGS. 8A, 8C and 8D, and has an elongate recess 115 formed longitudinally along its length on its upper and lower sides. The mouthpiece lies adjacent to and in contact with the inner core around the majority of its perimeter surface such that ducts 120 for the flow of milk are defined in the recesses between the mouthpiece 114 and the inner core 118. A plurality of apertures 122 are formed in the distal end of the mouthpiece 114 as described above with reference to the first embodiment of the invention. As can be seen from FIGS. 8B and 8C, when the mouthpiece 114 is not compressed, the ducts 120 are open. However, when the mouthpiece 114 is compressed, as shown in FIGS. 8B and 8D, the mouthpiece 114 is deformed into contact with the inner core 118 thereby closing the ducts 120.

Operation of the sixth embodiment of the present invention will now be described. In use, the teat 110 is attached to a feeding bottle in a known manner. The baby sucks on the mouthpiece 114, which is sufficient to cause a small flow of milk from the bottle into the ducts 120. The size of the inner core 118, the depth of the recesses 115 and the resulting ducts 120 are such that the sucking action of the baby and the resulting pressure difference between the baby's mouth and the inside of the bottle can cause only a small amount of milk to flow along the ducts 120. However, in order to obtain a full flow of milk from the bottle out of the teat 110, a baby must use a peristaltic feeding action as described above. At the point of compression of the mouthpiece 114, shown in FIGS. 8B and 8D, the inner surface of the mouthpiece 114 contacts the inner core 118 at the recesses 115 and closes the ducts 120, as described above. As the baby exerts a peristaltic feeding action on the mouthpiece 114, the compression points where the ducts 120 are closed move along the mouthpiece 114, thereby pushing ahead of it the milk in the ducts 120 until the compression point reaches the distal end of the mouthpiece 114 and the milk is expelled out of the apertures 122 into the baby's mouth. The reduction in pressure caused in the bottle by this action draws more milk into the ducts 120 behind the compression point. After the milk is expelled from the mouthpiece 114, the baby then repeats the feeding action starting with a compression point at the main body end of the mouthpiece 114 and draws the milk along the duct 120 and out of the mouthpiece 114 as described above.

One advantage of the sixth embodiment of the invention is that the inner core 118 does not need to be deformable as with the third, fourth and fifth embodiments, and so it can be made of a simple solid material, such as, but not limited to, silicone. The shape of this sixth embodiment also has the advantage that the baby can easily deform the mouthpiece with its tongue so making feeding with the correct peristaltic feeding action easier.

The sixth embodiment of the invention may also include one or more one-way valves, such as the flanges shown in the first embodiment, although such an alternative embodiment is not illustrated. This would have the added advantage that the first few feeding actions of the baby would be ‘non-nutritive’—i.e. would not result in milk flow out of the teat immediately. This would simulate the ‘let down reflex’ in breast feeding mentioned above, and thereby better simulate natural breast feeding.

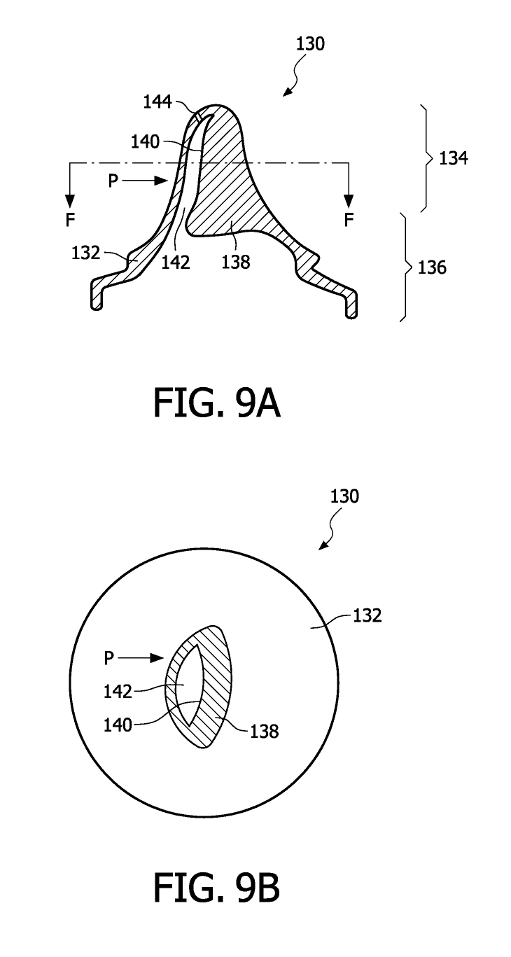

A seventh embodiment of a teat 130 of the present invention will now be described with reference to FIGS. 9A and 9B. The overall construction of the teat 130 is largely the same as that of the teat 10 of the first embodiment and comprises a hollow outer membrane 132 having a mouthpiece 134 and a main body 136. An inner core 138 is disposed within the mouthpiece 134 and extends slightly into the main body 136. The inner core 138 is integrally formed with the mouthpiece 134 and has an elongate arced face 140 that extends along the length of the inner core 138. The arced face 140, together with the inner surface of the mouthpiece 134, defines a duct 142 for the flow of milk, in use, from a feeding bottle (not shown) to which the teat 130 is to be attached, through the duct 142, and into a baby's mouth through an aperture 144 formed in a distal end of the mouthpiece 134 remote from the main body 136. Although only one aperture is shown in the exemplary drawing, it will be understood that a plurality of apertures (not shown) may be formed in the distal end of the mouthpiece 134. The membrane 132 and the inner core 138 are formed from a silicone material. As can be seen from FIGS. 9A and 9B, when the mouthpiece 134 is not compressed, the duct 142 is open. The duct 142 is maintained in an open position due to the resilience of the membrane 132. However, when the mouthpiece is compressed, as shown by arrow P, the duct 142 is closed by the mouthpiece 134 deforming and being urged into contact with the inner core 138, closing the duct 142.

Operation of the seventh embodiment of the present invention will now be described. In use, the teat 130 is attached to a feeding bottle (not shown) in a known manner. The baby sucks on the mouthpiece 134, which is sufficient to cause a small flow of milk from the bottle into the duct 142. The size of the mouthpiece 134, the inner core 138 and the resulting duct 142 is such that the sucking action of the baby and the resultant pressure difference between the baby's mouth and the inside of the bottle can cause only a small amount of milk to flow along the duct 134. However, in order to obtain a full flow of milk from the bottle out of the teat 130, a baby must use a peristaltic feeding action as described above. At the point of compression of the mouthpiece 134, shown by arrow P in FIG. 9A, the inner surface of the mouthpiece 134 contacts the arced face 140 of the inner core 138 and closes the duct 142, as described above. As the baby exerts a peristaltic feeding action on the mouthpiece 134, by which a compression wave is exerted by the baby's tongue on the mouthpiece 134 in the direction of the distal end of the mouthpiece 134, the compression point, shown by arrow P, where the duct 142 is closed moves along the mouthpiece 134, thereby pushing ahead of it the milk in the duct 142 until the compression point P reaches the distal end of the mouthpiece 134 and the milk is expelled out of the aperture 142 into the baby's mouth. The reduction in pressure caused in the bottle by this action draws more milk into the duct 142 behind the compression point P. After the milk is expelled from the mouthpiece 134, the baby then repeats the feeding action starting with a compression point P at the main body end of the mouthpiece 134 and draws the milk along the duct 142 and out of the mouthpiece 134 as described above.

One advantage of the seventh embodiment of the invention is that the arced face 139 of the inner core 138 is concave and so corresponds to the shape of a tongue. Furthermore, the mouthpiece at the compression point, shown by arrow P, can contact the arced face 140 and close the duct without the inner core 138 deforming. However, the invention is not limited thereto and the inner core 138 may deform at the compression point to provide an improved seal between the inner core 138 and the membrane 132.

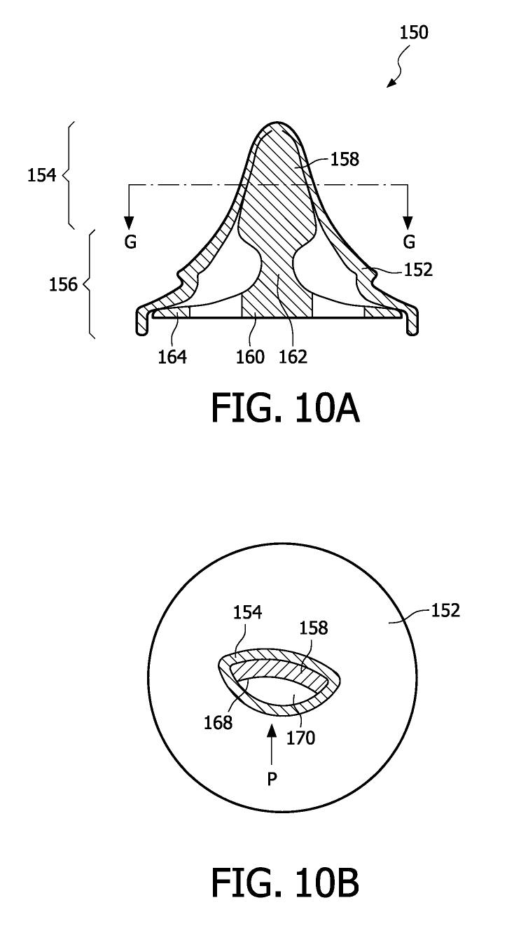

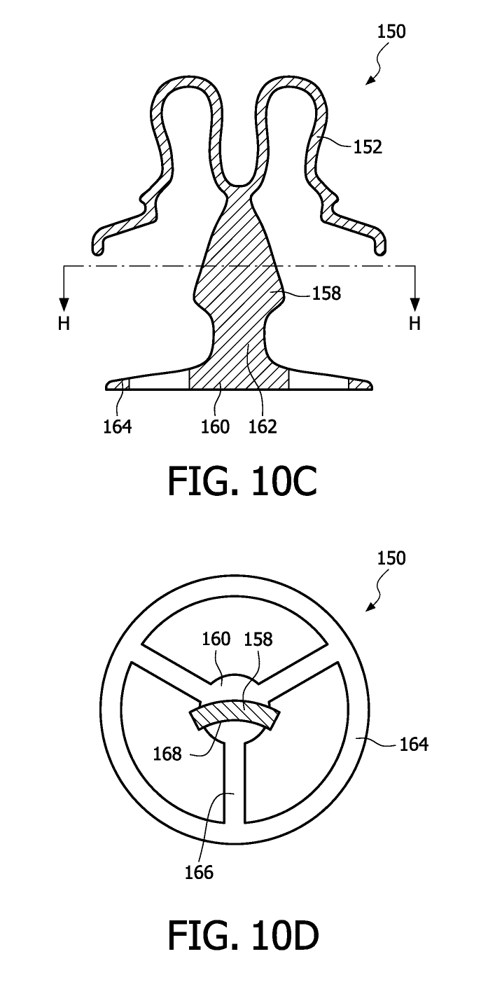

An eighth embodiment of a teat 150 of the present invention will now be described with reference to FIGS. 10A to 10D. The overall construction of the teat 150 is largely the same as the teat 130 of the seventh embodiment described above, and only the specific construction of the mouthpiece portion and inner core differs, as described below. The teat 150 comprises a hollow outer membrane 152 having a mouthpiece 154 and a main body 156. An inner core 158 is disposed within the mouthpiece 154 and extends slightly into the main body 156. A support frame 160 extends from an end of the inner core 158 located proximal to the main body 156 and extends through the main body 156. The support frame 160 comprises a support rod 162 extending from the inner core 158, a circumferentially extending rim 164 and spars 166 (refer to FIG. 10D) extending from the support rod 162 to the rim 164. The rim 164 and the spars 166 define open apertures through which, in use, milk can flow from a feeding bottle (not shown) to which the teat is to be attached into the teat 150. A section of the inner core 158 conforms to the contours of an inner surface of the mouthpiece 154 and the mouthpiece 154 lies adjacent to and in contact with the inner core 158 around the majority of its perimeter surface. However, the inner core 158 has an elongate arced face 168 formed longitudinally along its length, spaced from the inner surface of the mouthpiece 154, which together with the inner surface of the mouthpiece 154, defines a duct 170 for the flow of milk, in use, from a feeding bottle (not shown) to which the teat 150 is to be attached, through the duct 170, and into a baby's mouth through an aperture (not shown) formed in a distal end of the mouthpiece 154 remote from the main body 156. Although only one aperture is shown in the exemplary drawing, it will be understood that a plurality of apertures (not shown) may be formed in the distal end of the mouthpiece 154. The inner core 158 is fixedly mounted to the mouthpiece 154 at the distal end of the mouthpiece remote from the main body 156. In this exemplary embodiment the inner core 158 and mouthpiece 154 are integrally formed at the distal end. As can be seen from FIG. 10B, when the mouthpiece 154 is not compressed, the arced face 168 is spaced from the membrane of the mouthpiece and the duct 170 is open. However, when the mouthpiece is compressed, as shown by arrow P, the duct is closed by the mouthpiece 154 deforming and being urged into contact with the arced face 168 of the inner core 158, closing the duct 170.

Operation of the eighth embodiment of the present invention will now be described. In use, the teat 150 is attached to a feeding bottle (not shown) in a known manner. The circumferentially extending rim 164 of the support frame 160 locates against the feeding bottle to fixedly mount the support rod 162 and provide support for the inner core 158. The baby sucks on the mouthpiece 154, which is sufficient to cause a small flow of milk from the bottle into the duct 170. The size of the mouthpiece 154, the inner core 158 and the resulting duct 170 is such that the sucking action of the baby and the resultant pressure difference between the baby's mouth and the inside of the bottle can cause only a small amount of milk to flow along the duct 170. However, in order to obtain a full flow of milk from the bottle out of the teat 150, a baby must use a peristaltic feeding action as described above. At the point of compression of the mouthpiece 154, shown by arrow P in FIG. 10, the inner surface of the mouthpiece 154 contacts the arced face 168 of inner core 138 and closes the duct 170, as described above. As the baby exerts a peristaltic feeding action on the mouthpiece 154, by which a compression wave is exerted by the baby's tongue on the mouthpiece 154 in the direction of the distal end of the mouthpiece 154, the compression point P where the duct 170 is closed moves along the mouthpiece 154, thereby pushing ahead of it the milk in the duct 170 until the compression point, shown by arrow P, reaches the distal end of the mouthpiece 154 and the milk is expelled out of the aperture (not shown) into the baby's mouth. The reduction in pressure caused in the bottle by this action draws more milk into the duct 170 behind the compression point P. After the milk is expelled from the mouthpiece 154, the baby then repeats the feeding action starting with a compression point P at the main body end of the mouthpiece 154 and draws the milk along the duct 170 and out of the mouthpiece 154 as described above.

In order to facilitate cleaning of the above embodiment of the invention, the inner core 158 is fixedly mounted at the end of the mouthpiece 154 distal to the main body 156, however the membrane 152 of the one-piece teat 150 is capable of being inverted (i.e. turned inside out) in order to facilitate cleaning with the inner core 158 remaining attached to the mouthpiece 154, but being easily accessible (refer to FIG. 10C). The inner core 158 can be used to aid the inverting of the membrane 152, and the membrane can be easily flipped back over the inner core 158 after cleaning to reduce finger contact.

Manufacture of the teat 150 of the eighth embodiment can be achieved by moulding it inside out, which is a known teat manufacturing technique. The arrangement of this embodiment allows a simple manufacturing technique. The membrane 152 and inner core 156 are manufactured from a silicone material.

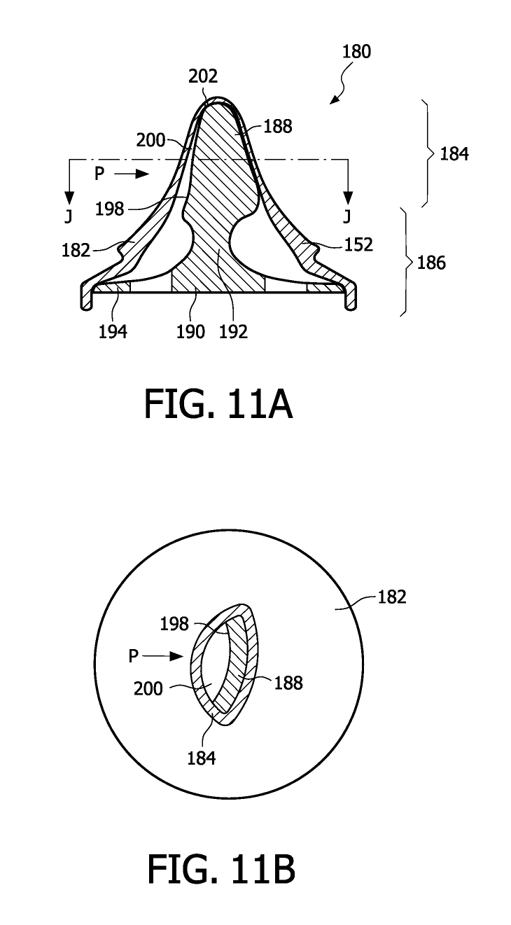

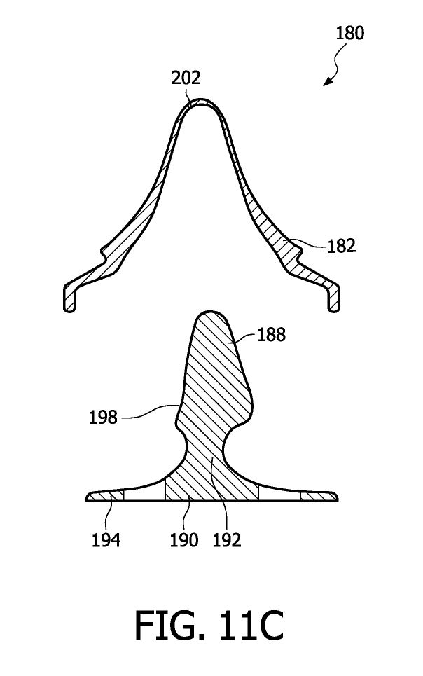

However, alternative configurations of teats similar to the seventh and eighth embodiments are intended to fall within the scope of the claims and the present invention, whereby the inner core is not integrally formed with the mouthpiece and an ninth embodiment of a teat 180 of the present invention will now be described with reference to FIGS. 11A to 11C. The overall construction of the teat 180 is largely the same as that of the first embodiment described above, and the teat 180 comprises a hollow outer membrane 182 having a mouthpiece 184 and a main body portion 186. An inner core 188 is disposed within the mouthpiece 184 and extends slightly into the main body 186. A support frame 190 extends from an end of the inner core 188 located proximal to the main body 186 and extends through the main body 186. The support frame 190 comprises a support rod 192 extending from the inner core 188, a circumferentially extending rim 194 and spars (not shown) extending from the support rod 192 to the rim 194. The rim 194 and the spars define open apertures through which, in use, milk can flow from a feeding bottle (not shown) to which the teat is to be attached into the main body 186 and the mouthpiece 184.

The inner core 188 has an elongate arced face 198 formed longitudinally along its length on its lower side. A section of the inner core 188 conforms to the contours of an inner surface of the mouthpiece 184 and the mouthpiece 184 lies adjacent to and in contact with the inner core 188 around the majority of its perimeter surface. However, the arced face 198 is spaced from the inner surface of the mouthpiece 184, which together with the inner surface of the mouthpiece 184, defines a duct 200 for the flow of milk, in use, from a feeding bottle (not shown) to which the teat 180 is to be attached, through the duct 200, and into a baby's mouth through an aperture 202 formed in a distal end of the mouthpiece 184 remote from the main body 186. Although only one aperture is shown in the exemplary drawing, it will be understood that a plurality of apertures (not shown) may be formed in the distal end of the mouthpiece 184. The inner core 188 is formed separate to the mouthpiece 184 and is insertable and removable therefrom. As can be seen from FIG. 11, when the mouthpiece 184 is not compressed, the arced face 198 is spaced from the membrane of the mouthpiece and the duct 200 is open. However, when the mouthpiece is compressed, as shown by arrow P, the duct is closed by the mouthpiece 184 deforming and being urged into contact with the arced face 198 of the inner core 188, closing the duct 200.

Operation of the ninth embodiment of the present invention will now be described. In use, the inner core 188 is inserting into the membrane 182 and disposed in the mouthpiece 174. The inner core 188 locates against an inner surface thereof such that the inner surface and the arced face define the duct 200. The teat 180 is attached to a feeding bottle (not shown) in a known manner. The circumferentially extending rim 194 of the support frame 190 locates against the feeding bottle to fixedly mount the support rod 192 and provide support for the inner core 188. The baby sucks on the mouthpiece 184, which is sufficient to cause a small flow of milk from the bottle into the duct 200. The size of the mouthpiece 184, the inner core 188 and the resulting duct 200 is such that the sucking action of the baby and the resultant pressure difference between the baby's mouth and the inside of the bottle can cause only a small amount of milk to flow along the duct 200. However, in order to obtain a full flow of milk from the bottle out of the teat 180, a baby must use a peristaltic feeding action as described above. At the point of compression of the mouthpiece 184, shown by arrow P in FIG. 11, the inner surface of the mouthpiece 184 contacts the arced face 198 of inner core 188 and closes the duct 200, as described above. As the baby exerts a peristaltic feeding action on the mouthpiece 184, by which a compression wave is exerted by the baby's tongue on the mouthpiece 184 in the direction of the distal end of the mouthpiece 184, the compression point P where the duct 200 is closed moves along the mouthpiece 184, thereby pushing ahead of it the milk in the duct 200 until the compression point, shown by arrow P, reaches the distal end of the mouthpiece 184 and the milk is expelled out of the aperture 202 into the baby's mouth. The reduction in pressure caused in the bottle by this action draws more milk into the duct 200 behind the compression point P. After the milk is expelled from the mouthpiece 184, the baby then repeats the feeding action starting with a compression point P at the main body end of the mouthpiece 184 and draws the milk along the duct 200 and out of the mouthpiece 184 as described above.

Manufacture of the teat 180 of the ninth embodiment can be achieved by moulding the inner core 188 and the membrane 182 as separate components. The two individual components are then assembled before use. An advantage of the present embodiment is that it simplifies manufacture of each component. In the present exemplary embodiment the inner core 182 is formed from a thermoplastic, but the invention is not limited thereto and the inner core can be formed from a silicone, 2K part or any suitable material. The membrane 182 is formed from a silicone 30 shore material, although the invention is not limited thereto.

One advantage of the ninth embodiment of the invention is that the inner core 188 does not need to be deformable as with the seventh and eighth embodiments, and so it can be made of a simple solid material, such as, but not limited to, a thermoplastic.

In order to facilitate cleaning of the above embodiment of the invention, the inner core 188 is removable from the mouthpiece 184. This is achievable by inverting the membrane 182 and then the membrane 182 can be cleaned separately from the inner core 18. Furthermore, another advantage of this embodiment is that when the inner core 188 is removed, the hollow outer membrane 182 can be used as a conventional teat without the inner core 188 being present.

The ninth embodiment of the invention may also include one or more one-way valves, such as the flanges shown in the first embodiment, although such an alternative embodiment is not illustrated. This would have the added advantage that the first few feeding actions of the baby would be ‘non-nutritive’—i.e. would not result in milk flow out of the teat immediately. This would simulate the ‘let down reflex’ in breast feeding mentioned above, and thereby better simulate natural breast feeding.

It will be appreciated that the teats 130,150,170 of the seventh to ninth embodiments of the invention are configured so that the above-described peristaltic feeding action provides the baby with the most amount of milk, compared to if the baby was to use a sucking or chewing action. Accordingly, the baby is rewarded for using the same feeding action as with natural breast feeding, and so the problem of nipple confusion in switching between bottle feeding and breast feeding is prevented since the baby learns to use the same feeding action for both feeding methods. It should be noted that the wall thickness and stiffness of the membrane can be chosen and manufactured to control the flexibility of the teat and reward the sucking and peristaltic feeding action in any proportion.

All of the above embodiments of the present invention reward a baby during bottle feeding for using the natural peristaltic feeding action by delivery of the largest flow of milk compared to that which would be delivered if the baby only used a sucking action. Therefore, the baby is encouraged to use the same feeding technique when bottle feeding as when breast feeding, and so does not ‘un-learn’ the natural breast feeding action, making it easier to interchange between bottle feeding and breast feeding, and avoiding nipple confusion in the baby. Furthermore, the construction of each embodiment is such that a peristaltic feeding action is easy for the baby to accomplish.

In addition to the above, since the various embodiments of the teat of the invention encourage a baby to use the correct peristaltic feeding action, the teat can be used to teach a baby the correct breast feeding action if the baby has not instinctively developed such a skill itself, as can sometimes be the case.

Further advantages of the teat of the invention is that since the mouthpiece of the teat includes an inner core, the core provides a degree of support to the mouthpiece, and so the membrane and mouthpiece can be manufactured without needing to consider resistance to collapsing, which is an important design criteria to be considered in the manufacture of conventional hollow teats which do not have a core disposed within the mouthpiece.

Yet another advantage of the present invention is that peristaltic action, which the baby is encouraged to use, is capable of creating a significant pressure difference between the interior of the feeding bottle and ambient surroundings, much more than could be produced by the baby using a sucking action alone. Accordingly, a baby will be able to obtain milk from a feeding bottle using a teat of the present invention, even if the pressure in the bottle is lower than that of the ambient surroundings, to a much greater degree than would be possible using conventional teats. Therefore, in feeding bottles which incorporate a valve to equalize the negative pressure within a feeding bottle, a much larger tolerance on the opening pressure of the valve is possible, and so leakage from the bottle is easier to avoid.

It will be appreciated that in embodiments shown and described above, the inner core of the teat is preferably removable from the mouthpiece portion to facilitate cleaning of the teat, although the embodiments of the invention are not limited to such a feature. In particular, in embodiments seven and eight the inner core is integrally formed with the mouthpiece so that the teat is manufactured as a single component which reduces the chance of incorrect assembly of the teat during use.

In addition to the embodiments described above, it is intended for the following features, independently or in combination where appropriate, to fall within the scope of the invention:

a) Teat may include a main body from which the mouthpiece extends, and the inner core extends from the mouthpiece into the main body;

b) the teat may comprise a plurality of flexible flanges;

c) the or each flange of the teat may be secured to the mouthpiece and is biased against the inner core;

d) the or each flange of the teat may be formed integrally with the mouthpiece;

e) the or each flange of the teat may be secured to the inner core and biased against the mouthpiece;

f) the or each flange of the teat may be formed integrally with the inner core;

g) the incompressible material in the flexible tube may be silicone gel;

h) the teat may be inverted to aid cleaning of the teat and/or to facilitate removal of the inner core;

i) the inner core may be more rigid than the mouthpiece; and

j) a baby feeding bottle including a teat of the invention may include a pressure release valve to equalize negative pressure within the bottle during feeding.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A teat for use with a feeding bottle having a mouthpiece on which a baby sucks during feeding with one or more apertures therein for the flow of milk out of the teat, a main body from which the mouthpiece extends, and an inner core disposed within the mouthpiece to define a fluid duct between the mouthpiece and the inner core, the mouthpiece and the inner core being configured such that during feeding, the mouthpiece and/or the inner core deform so as to make a peristaltic action possible which causes milk to flow along said duct and through said aperture.

2. A teat according to claim 1 wherein the inner core within the mouthpiece defines a plurality of separate ducts for the flow of milk along the ducts and out through the one or more apertures.

3. A teat according to claim 1 comprising at least one valve means within the mouthpiece which divides the or each duct into discrete sections and which is operable to allow milk to flow in one direction out of the teat but closes to resist the flow of milk in the opposite direction.

4. A teat according to claim 3 wherein the valve means comprises at least one flexible flange extending between the mouthpiece and the inner core which divides the or each duct into discrete sections and which is moveable to allow milk to flow in one direction out of the teat but closes to resist the flow of milk in the opposite direction.

5. A teat according to claim 1 wherein the inner core includes an absorbent outer surface.

6. A teat according to claim 5 wherein the absorbent outer surface of the inner core is made from foam.

7. A teat according to claim 1 wherein the inner core comprises a sealed flexible tube filled with incompressible material.

8. A teat according to claim 7 wherein the incompressible material is a fluid.

9. A teat according to claim 7 wherein the tube is made from an elastic material.

10. A teat according to claim 7 wherein the tube has a corrugated surface with the corrugations extending in a longitudinal direction of the mouthpiece.

11. A teat according to claim 1 wherein the mouthpiece includes elongate channels along its length which comprise said duct and the inner core is flexible and includes longitudinal ribs extending into said channels, such that compression of the inner core causes the longitudinal ribs to extend further into the channels to close the channels and thereby close the ducts.

12. A teat according to claim 1 wherein the inner core comprises at least one elongate recess along its length to define the or each duct between the mouthpiece and the inner core within the recess.

13. A teat according to claim 1 wherein the inner core is removable from the mouthpiece.

14. A teat according to claim 1 wherein a perimeter surface of the inner core lies against the mouthpiece and a face is formed in the inner core, spaced from the mouthpiece, the duct being defined between said face and the mouthpiece.

15. A teat according to claim 14 wherein the inner core is integrally formed with the mouthpiece.

16. A teat according to claim 15 wherein an end of the inner core, distal to the main body, is integrally formed with the mouthpiece.

17. A teat according to claim 14 wherein a support frame extends from the inner core through the main body and which, during use, locates against the main body and/or a bottle to support the inner core.

18. A teat according to claim 1 wherein the inner core includes a hollow bore extending longitudinally there through for the additional flow of milk.

19. A baby feeding bottle including a teat according to claim 1.
